(19) United States
(12) Patent Application Publication
(10) Pub. No.: US 2010/0293376 A1
(43) Pub. Date: Nov. 18, 2010

(54) METHOD FOR AUTHENTICATING A CLENT MOBILE TERMINAL WITH A REMOTE SERVER

(75) Inventor: François Colon, Marseille (FR)

Correspondence Address: HARNESS, DICKEY & PIERCE, P.L.C., P.O. BOX 828, BLOOMFIELD HILLS, MI, 48303, US

(73) Assignee: MIYOWA, Marseille (FR)

(21) Appl. No.: 12/760,790

(22) Filed: Apr. 15, 2010

(30) Foreign Application Priority Data
Apr. 16, 2009 (FR) 0901849

(51) Int. Cl. H04L 9/32; H04L 9/08

(52) U.S. Cl. 713/168; 380/278

(57) ABSTRACT

The disclosure relates to a method and a device for authenticating a client mobile terminal on a remote server of said terminal, with said server sending a challenge to said mobile terminal in advance, said mobile terminal having to respond to the challenge, to authenticate at the same time, by transmitting a response consisting in encoding said challenge combined with a secret key known to said terminal and the same time to the server, wherein the secret key is hidden in a media file recorded in the mobile terminal using steganography.

### CROSS-REFERENCE TO RELATED APPLICATIONS

This application claims the benefit and priority of French Application 09/01849, filed on Apr. 16, 2009, which is incorporated by reference herein.

### TECHNICAL FIELD OF THE INVENTION

This invention describes a method and a device for the authentication of a mobile terminal with a remote server of said terminal in a secure manner. It also describes a mobile terminal for the implementation of the method and/or intended to be used in the device. The invention relates to the general technical field of protocols for protecting the authentication of a client mobile terminal with a server, which is part of a communication network. It especially concerns methodes and devices for checking the identity of a client using said so-called challenge/response technique. The invention is preferably applied, but not limited, to the authentication of a client for: opening an instant messaging session on a mobile telephone, activating the functions on a mobile terminal, sending data on a secure communication network (requiring the use of chip cards), etc.

### BACKGROUND

Mobile terminals (like mobile telephones, laptops, PDAs, BlackBerry®) are generally equipped with some functions, which make it possible, for instance, to check mails, open an instant messaging session, communicate on a Blog, transfer secure data, etc. Each of these functions is implemented by a specific computer application (or software) integrated in the mobile terminal. If a user wishes to activate one of these functions, the associated computer application issues an authentication request to the server in advance, which provides the services corresponding to said function. The server will activate the function only once it has identified the user.

The so-called challenge/response authentication technique is well-known to those skilled in the art. Before activating the function, the server sends a challenge to the mobile terminal. The latter must then transmit a response to this/her challenge, which is only known to the client and the server. It is only if the response is correct, that the server authenticates the client and activates the function. A basic example of this so-called challenge/response technique is the identification with a password: the server asks the client for a password associated with an identifier (this is the challenge); the client sends his/her password associated with his/her identifier (this is the response). Each password and each identifier must be stored on the server side. If the password and the identifier match, the server activates the function. The main problem of this trivial identification technique is that a fraudor can easily intercept the password and the identifier and can illegally pretend to be the client.

There is a more complex so-called challenge/response technique called CRAM (“Challenge Response Authentication Mechanism”). The purpose of this CRAM method is to prove one's identity to the server without ever having one's password or identifier transit. Referring to FIG. 1, the CRAM method consists in:
sending an authentication request Req from the mobile terminal TM to the server S;
sending a challenge Def comprising a random number n, from the server S to the mobile terminal TM;
generating a response R to the challenge Def, at the mobile terminal TM, consisting of encoding the random number n combined with a secret key K associated with the client (R=Enc[n, K]). This secret key K is only known to the server S and the mobile terminal TM, while the encoding algorithm can be public;
generating a standard response R′ at the server S, consisting of encoding the random number n combined with the secret key K associated with the client (R′=Enc[n, K]);
sending the R, from the mobile terminal TM to the server S;
comparing the client's response R with the standard response R′ at the server S;
if R=R′ then the server S authenticates the client and activates the function.

This CRAM method is especially advantageous, as even if a fraudor intercepts the response R and knows the encoding algorithm, he/she will not be able to find the secret key K, as he will not know the value of the random number n. Similarly, if a fraudor intercepts the challenge Def and thus knows the random number n, he:she will not be able to establish a response, as he/she will not know the value of the secret key K.

However, the efficiency of this CRAM method is limited if the client mobile terminal is stolen. Indeed, in this case, it becomes easy to find the secret key in the application resources. Besides, all the secret keys associated with the clients are to be stored on the server side. Thus, if the server is hacked, all the secret keys can be discovered. In any case, knowing the secret keys is obviously highly prejudicial, as a fraudor can then easily pretend he/she is a client. Other so-called challenge/response techniques have also been described in the patent documents WO 2006/084183 (QUALCOMM), U.S. Pat. No. 6,377,691 (MICROSOFT) or even EP 0.915.590 (PHONE.COM).

Given this situation, the main technical problem that the invention aims at solving is offering a new authentication protocol based on the so-called challenge/response technique using a secret key, since this new authentication protocol is more secure than the previously known protocols, especially the CRAM type ones. Another objective of the invention is to make hacking of a mobile terminal for finding the secret keys more difficult. Yet another objective of the invention is to make hacking of a server for finding the secret keys more difficult.

### SUMMARY OF THE INVENTION

The invention aims at remedying the problems associated with the technical problems encountered in the securing of communication protocols. More precisely, the invention aims at a method for authenticating a client mobile terminal with a remote server of said terminal, with said server sending a challenge to said mobile terminal in advance, and said mobile terminal having to respond to a challenge by transmitting a response consisting of encoding said challenge combined with a secret key known to both said terminal and server. This method is remarkable in that the secret key is hidden in a media file recorded on the mobile terminal using steganography. This technical solution is especially advantageous, as even if a third person succeeds in hacking the mobile terminal, he/she will find it very difficult to detect the hidden secret key. Indeed, steganography makes it possible to hide the secret key in the media file in such a manner that the presence thereof is imperceptible and thus cannot be detected by a fraudor.

Specifically, the method, which is object of the invention consists in:
sending an authentication request from the mobile terminal to the server;
sending a challenge from the server to the mobile terminal,
extracting the secret key from the media file by executing a reverse steganography algorithm at the mobile terminal,
generating:
   a response to the challenge, at the mobile terminal, with said response consisting of encoding the challenge combined with the secret key using an encoding algorithm known to the server and said terminal,
   a standard response to the challenge, at the server, with said standard response consisting of encoding the challenge combined with the secret key using the same encoding algorithm,
sending the response from the mobile terminal to the server;
comparing the response received with the standard response, at the server,
authenticating the mobile terminal if the response matches the standard response.

One can provide for an initialisation phase consisting in:
sending an initial request to download the resources of a computer application associated with a function from the mobile terminal to the server, with said request including a client password known to the server,
authenticating the received client password, at the server, and generating a secret key,
hiding the secret key in a media file at the server, by applying a steganography algorithm bootstrapped by the client password,
transferring the resources of the computer application, including the media file containing the secret key, from the server to the mobile terminal.

In addition to the secret key, the challenge preferably consists of a random number and a time marker, with the generation of the response at the mobile terminal and the standard response at the server consisting in encoding: the secret key, said random number and said time marker using an algorithm known to said server and terminal. There are multiple secret keys for the same user for reinforcing the security of the authentication protocol. To do so:
several secret keys are associated with indexes in a table, with the latter being hidden in a media file recorded on the mobile terminal using steganography,
the challenge sent by the server includes an index from the table,
the response sent by the mobile terminal includes the secret key associated with the index.

If there are multiple secret keys, the method advantageously consists in:
sending an authentication request from the mobile terminal to the server;
sending a challenge comprising an index in the table from the server to the mobile terminal,
extracting the media file table by executing a reverse steganography algorithm, at the mobile terminal, and then extracting the secret key associated with the index from said table,
generating:
   a response to the challenge, at the mobile terminal, with said response consisting in encoding the challenge combined with the secret key associated with the index using an encoding algorithm known to the server and said terminal,
   a standard response to the challenge, at the server, with said standard response consisting in encoding the challenge combined with the secret key associated with the index using the same encoding algorithm,
   sending the response from the mobile terminal to the server;
   comparing, at the server, the response received with the standard response, authenticating the mobile terminal if the response matches the standard response.

One can also provide for an initialisation phase consisting in:
sending an initial request to download the resources from a computer application associated with a function from the mobile terminal to the server, as said request includes a client password known to the server,
authenticating the received client password, at the server, and generating a table associating the indexes with secret keys,
hiding the table in a media file at the server, by applying a steganography algorithm bootstrapped by the client password,
transferring the resources of the computer application, including the media file containing the table, from the server to the mobile terminal.

In addition to the index, the challenge advantageously consists of a random number and a time marker, with the generation of the response at the mobile terminal and the standard response at the server consisting in encoding: the secret key associated with the index, said random number and said time marker using an algorithm known to said server and terminal. The media file is preferably an image, audio or video file, which is part of the resources of the computer application downloaded on the mobile terminal.

The media file including the secret key or the table is preferably recorded in the memory of the server in such a manner that if a third person succeeds in hacking said server, it will be very difficult, or even impossible for him/her to detect the hidden secret key(s). If there is only one secret key, before generating the standard response, the server extracts the secret key from the media file recorded in its memory by executing a reverse steganography algorithm. If there is a secret keys table, before generating the standard response, the server extracts the table from the media file recorded in its memory by executing a reverse steganography algorithm, and then extracts the secret key associated with the index from said table. Preferably, the encoding algorithm, which makes it possible to generate the response at the mobile terminal and the standard response at the server, is a coding and encryption algorithm, which integrates a hashing function.

Another aspect of the invention is a device for authenticating a client mobile terminal with a remote server of said terminal, with said server sending a challenge to said mobile terminal in advance, with said mobile terminal being configured to respond to the challenge by transmitting a response consisting in encoding said challenge combined with a secret key known to both said terminal and server. This device is remarkable in that the secret key is hidden in a media file recorded on the mobile terminal using steganography.

There are several secret keys for the same user for reinforcing the security of the authentication device.

### To do so:

the mobile terminal includes a memory area, where a media file is recorded, in which a table associating the indexes with the secret keys is hidden using steganography,
the server comprises a processor configured for sending a challenge including an index from the table,
the mobile terminal comprises a processor configured to issue a response to the challenge, with said response including the challenge combined with the secret key associated with the index transmitted with said challenge.

In the latter case, it is advantageous if the mobile terminal comprises a processor configured to:
send an authentication request to the server;
extract the table from the media file by applying a reverse steganography algorithm, and extract the secret key associated with an index transmitted by the server from said table,
execute an algorithm, which makes it possible to encode a challenge signal combined with the secret key associated with the index for generating a response to said challenge,
send the response to the server, and the server must comprise a processor configured to:
   generate and send a challenge signal comprising an index from the table to the mobile terminal,
   execute an algorithm, which makes it possible to encode a challenge signal combined with the secret key associated with the index for generating a standard response to said challenge,
   compare the response transmitted by the mobile terminal with the standard response,
   authenticate the mobile terminal if the response corresponds to the standard response.

The server preferably comprises of a processor configured to:
generate the table associating the indexes with the secret keys,
execute a steganography algorithm, which makes it possible to hide said table in a media file,
transfer this media file to the memory area of the mobile terminal.
   Yet another aspect of the invention relates to a mobile terminal intended to be used to implement the method in accordance with the invention, with said terminal including a memory area, wherein a media file recording a secret key is hidden using steganography, or preferably a table associating the indexes with the secret keys.

### BRIEF DESCRIPTION OF THE FIGURES

Other characteristics and advantages of the invention will be revealed upon reading the description given below, with reference to the appended figures, which illustrate:

The aforementioned FIG. 1 illustrates the various steps of the CRAM authentication method of the prior art;

FIG. 2 illustrates the initialisation step of a primary authentication method in accordance with the invention;

FIG. 3 illustrates the insertion of a secret key into an image using steganography;

FIG. 4 illustrates the various steps of the first authentication method which is object of the invention;

FIG. 5 illustrates the initialisation step of a second authentication method in accordance with the invention;

FIG. 6 illustrates the insertion of a secret keys table in an image using steganography; and

FIG. 7 illustrates the various steps of the second authentication method which is object of the invention.

For more clarity, identical or similar elements are marked by identical reference signs on all the figures.

### DETAILED DESCRIPTION OF AN EMBODIMENT

The authentication method which is object of the invention calls upon at least one client mobile terminal TM and one remote server S of said terminal. The client mobile terminal TM can be a mobile telephone, a laptop, a personal digital assistant (PDA) type of device or any other mobile communication terminal (BlackBerry®, . . . ). The mobile terminal TM is configured to connect with a communication network, preferably MSM®, Jabber®, Yahoo!®, etc. type of mobile telephone networks.

In a manner that is well known to those who are skilled in the art, it is equipped with a processor, configured to execute one or more programmes, sub-programmes, microprogrammes or all other types of equivalent software, so as to manage the different steps of the challenge/response type of authentication protocol, which will be described in detail later. The mobile terminal TM also has a certain number of built-in computer applications (programmes, sub-programmes, microprogrammes, . . . ), for implementing the various functions integrated therein: mails, blog, instant messaging, secure data transfer, etc.

The server S is, preferably but not exclusively, a virtual server (or “gateway”) comprising a computer or a computer programme configured to provide certain functions (mails, blog, . . . ) and instant messaging services, in particular, to client mobile terminals TM connected thereto. The server S is preferably associated with different instant messaging communities. It is connected to a communication network (MSM®, Jabber®, Yahoo!®, or other) usually used to implement the various aforementioned functions.

In a well-known manner, this server S is equipped with a processor configured to execute one or more programmes, sub-programmes, microprogrammes or all other types of equivalent software, so as to manage the different steps of the challenge/response type of authentication protocol, which will be described in detail later. The authentication protocol implemented in this invention is based on the challenge/response principle: the server S and the mobile terminal TM share the knowledge of at least one secret key Ki and a computation algorithm Enc of a response R, R′ to a challenge Def. The computation algorithm Enc can be public, i.e. known to everyone. The secret key Ki and the computational function Enc are integrated in the resources of the mobile terminal TM and the server S.

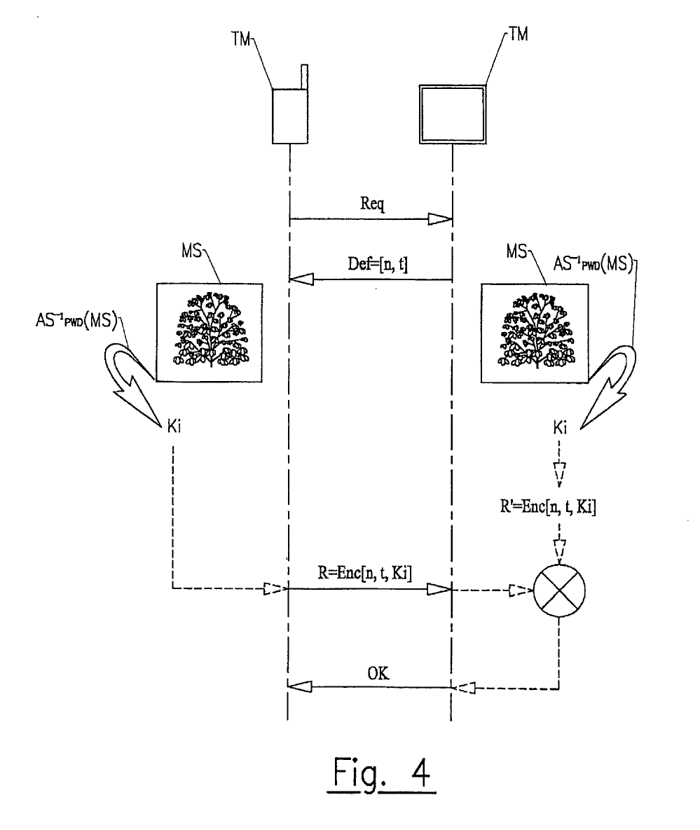

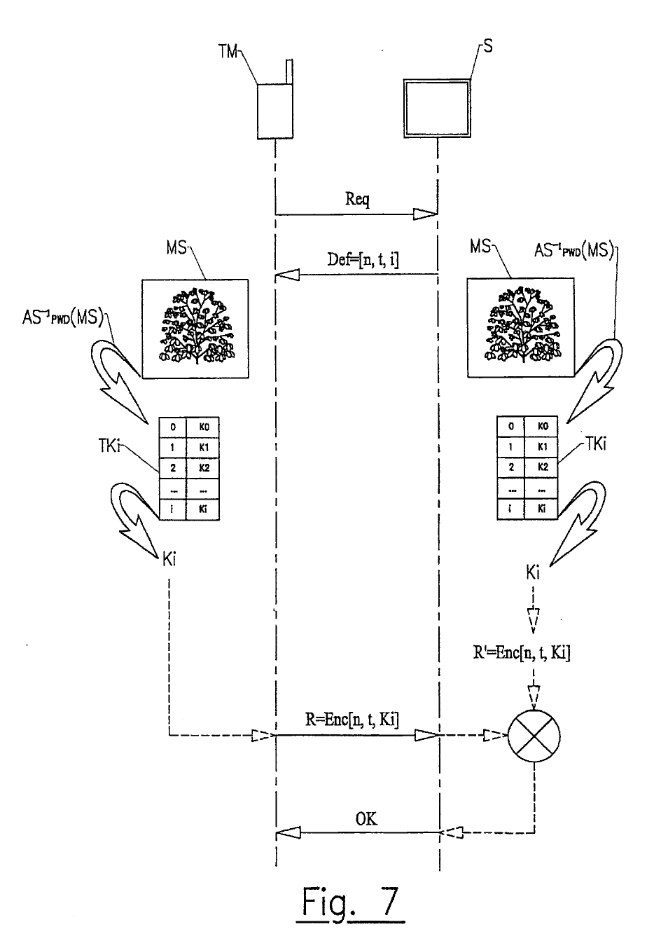

Referring to FIGS. 4 and 7, for instance, the mobile terminal TM sends an authentication request Req to the server S to activate one or more of the aforementioned functions. The request Req is issued on a wired or wireless transmission channel like the internet, radio, GSM, or other, enabling data exchange between the server S and the mobile terminal TM. The request Req advantageously includes the identification of the client (for example his/her username) and an indication of the function(s) to be activated.

Before activating the function(s), the server S must authenticate the mobile terminal TM. To do so, it sends a challenge signal Def to the mobile terminal TM. The latter is issued on the transmission channel (or another channel) linking the mobile terminal TM to the server S. The challenge Def mainly includes a random number n.

In practice, this number n is a hexadecimal integer in several bits generated by a pseudo-random number generator (PNRG) integrated in the server S. The challenge can also include a time marker t. For example, it is possible to implement the marker t as a hexadecimal number incremented each time a request Req is accepted (thus changing with time).

However, other techniques are known to the persons skilled in the art for implementing the marker t. In practice the time marker t corresponds to the date of creation of the random number n. The number n and the marker t are used to increase the entropy (difficulty of falsification) of the challenge Def.

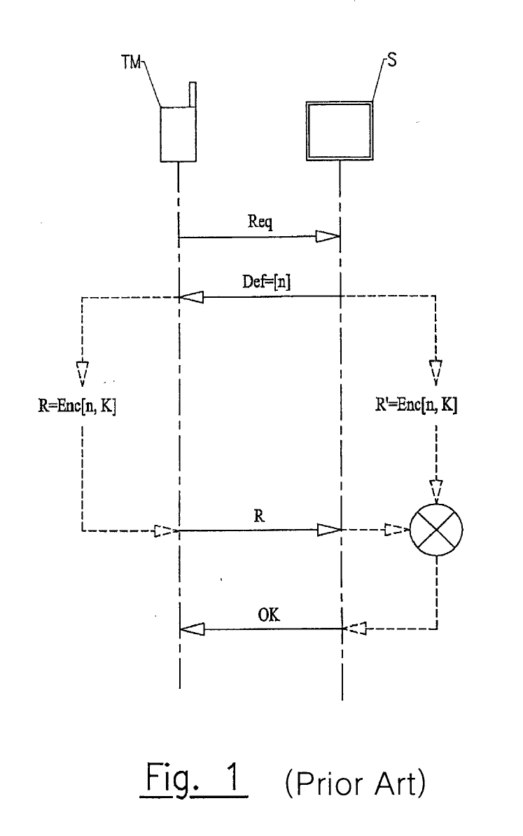

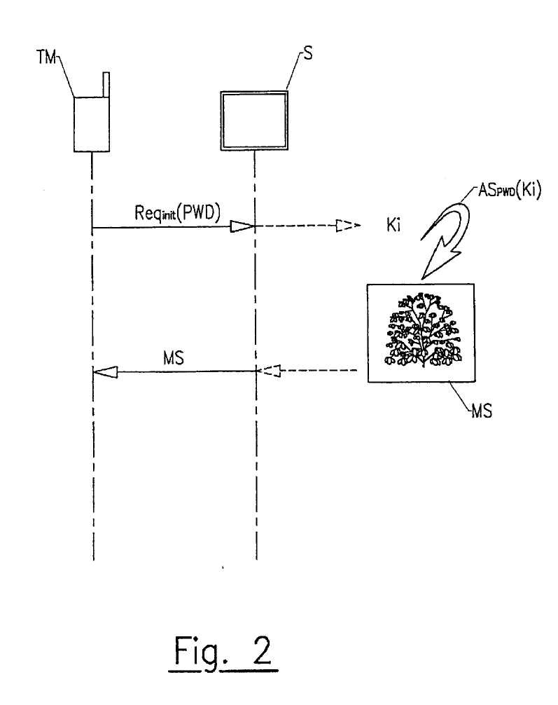

In order to be authenticated, the mobile terminal TM must respond to the challenge Def by transmitting a response R consisting in encoding the challenge Def combined with a secret key Ki known to said terminal as well as to the server S. According to a first embodiment of the invention shown in FIGS. 2 to 4, a secret key Ki is hidden in a media file MS recorded on the mobile terminal TM using steganography. Steganography is a technique, which makes it possible to hide information (the secret key Ki) in a medium (the media file MS) in such a manner that the presence of the information on the medium is imperceptible (visually as well as audibly) and thus cannot be detected by a person.

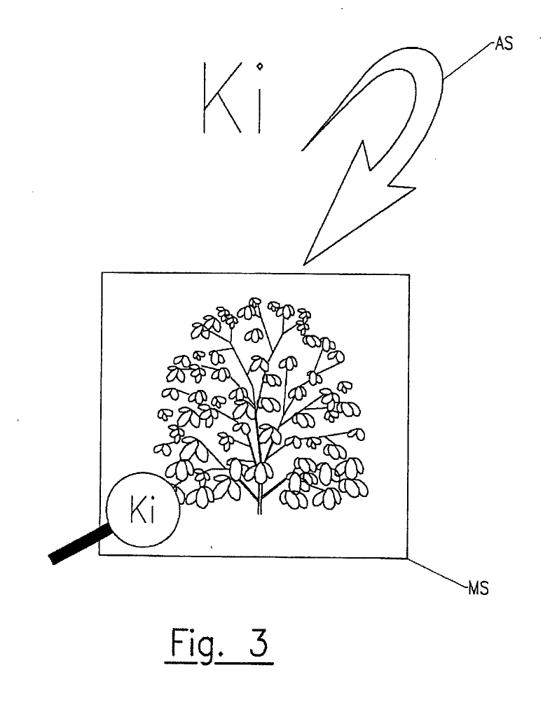

In this invention, the secret key Ki is advantageously presented in the form of a hexadecimal number in multiple bits. The media file MS is generally a binary file, which is part of the resources of the computer application, associated with a function loaded in the mobile terminal TM. In practice, it involves an image file (JPEG, MPEG, etc.), an audio file (MP3, etc.) or a video file (MPEG2, MPEG 4, etc.). for example it can be a wallpaper, an audio or video welcome message. The case where the secret key Ki is hidden in a JPEG or MPEG image is illustrated in FIG. 3: if the image shows a tree with leaves, the secret key Ki can be hidden in the pixels corresponding to one of the leaves of the tree or elsewhere, since the place where said password will be hidden cannot necessarily be controlled.

The steganography algorithm AS used preferentially is of the type using the LSB (Least Significant Bit) technique. This algorithm consists in replacing the low order bits of the bytes coding the light intensity of the image pixels by the bits of the secret key. By modifying a low order bit, it is possible to slightly modify the light intensity or the shade of a pixel of the image.

This slight modification is imperceptible to the human eye and not detected when all the bytes coding the light intensity of the image pixels are analysed. For example, if the light intensity of the image pixels is coded by the following bytes: 001-000-100-110-101 and the secret key Ki matches number: 11111, then the modified image will be coded by the following bytes: 001-001-101-111-101.

The same steganography algorithm can be used for hiding the secret key Ki in a video file. In an audio file, the information can be hidden in imperceptible variations of the sound coded with least significant bits. Naturally, any other steganography algorithm suitable to the person skilled in the art can be used.

The media file MS in which the secret key Ki is hidden, is stored in a memory area of the mobile terminal TM. This media file MS can be recorded as soon as the mobile terminal TM is designed but has preferably been downloaded during an initialisation phase shown in FIG. 2. In this case, the mobile terminal TM sends an initial request Reqᵢₙᵢₜ to the server S to download the resources of a computer application associated with one or more functions that the client wishes to obtain. This initial request comprises a password PWD possibly associated with the client identifier.

When the server S receives this initial request Reqᵢₙᵢₜ, it authenticates the password and generates the secret key Ki. Then the server S applies a steganography algorithm AS_{PWD} bootstrapped by the password PWD, to hide the secret key Ki in a media file MS, which is preferably part of the resources of the computer application. The steganography algorithm AS_{PWD} is specific to each password and thus to each client. Then the server S transfers the resources of the computer application, including the media file MS containing the secret key Ki to the mobile terminal TM. Even if the media file MS is intercepted by a fraudor during the transmission thereof to the mobile terminal TM, the fraudor will practically have no chance to detect the secret key Ki. Only the secret key Ki can be stored on the server S side. However, in order to optimise the security of the method which is subject of the invention, the media file MS containing the secret key Ki is preferably recorded in the memory of the server S.

Referring to FIG. 4, when the mobile terminal TM receives the challenge Def, it extracts the secret key Ki from the media file MS by executing a reverse steganography algorithm AS_{PWD}, which is specific to each password PWD and thus to each client. This reverse steganography algorithm AS_{PWD} can be installed in the mobile terminal TM soon after the conception thereof or, preferably, is part of the resources downloaded during the initialisation phase. A response R to the challenge Def is then generated, with said standard response consisting in encoding the secret key Ki combined with said challenge and possibly the random number n and the time marker t using an encoding algorithm Enc known to the server S and the mobile terminal TM. At the same time, the server S generates a standard response R′ consisting in encoding the secret key Ki combined with the challenge Def, and possibly the random number n and the time marker t using the same encoding algorithm Enc. If the media file MS including the secret key Ki is recorded in the memory of the server S, the latter pre-extracts said key from the file by executing the reverse steganography algorithm AS_{PWD} matching the password PWD. After having generated its response R, the mobile terminal TM transmits it to the server S. The latter compares the response R received using a comparison algorithm with the standard response R′ that it has generated. If the response R matches the standard response R′, the mobile terminal TM is authenticated and the server S can activate the functions desired by the client. If not so, an error message can be sent from the server S to the mobile terminal TM.

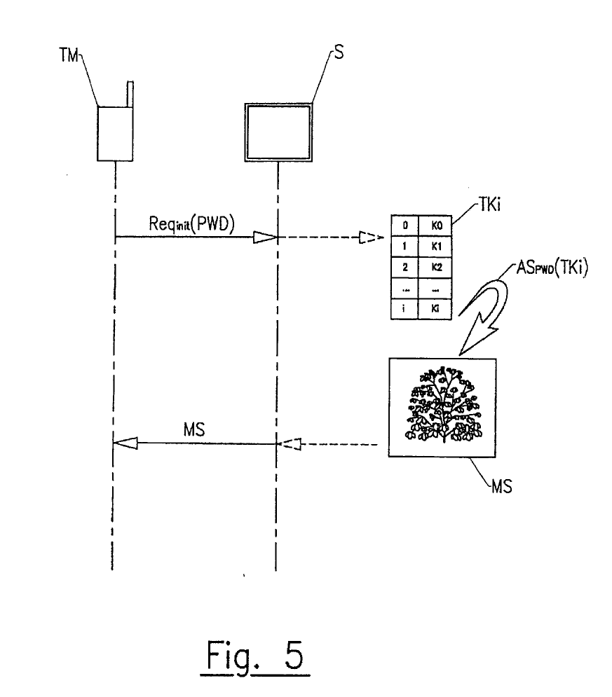

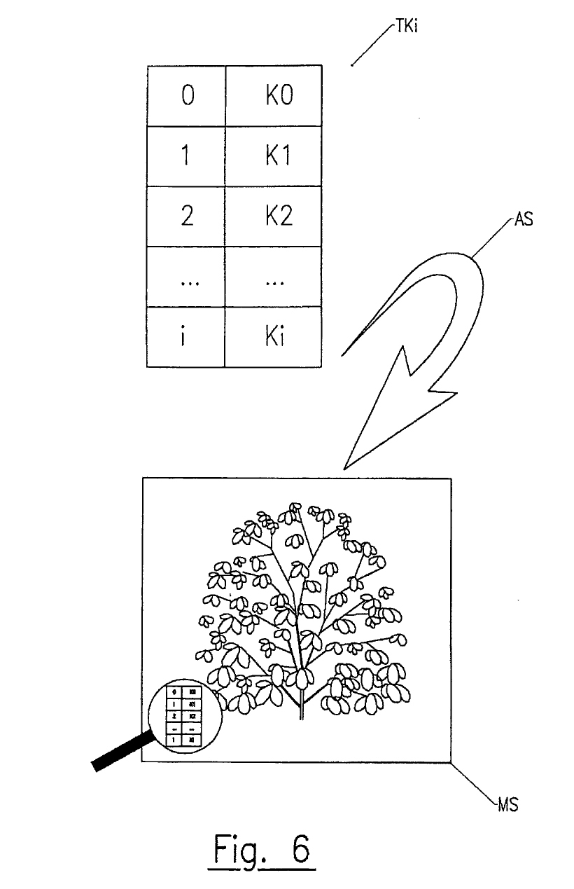

According to a second embodiment of the invention shown in FIGS. 5 to 7, there are multiple secret keys for the same user. Referring to FIG. 6, multiple secret keys K0, K1, . . . Ki, are associated with the indexes 0, 1, . . . , i in a table TKi. In principle, each secret key and index are in the form of hexadecimal numbers. The table TKi is then in the form of an arrangement of hexadecimal numbers, which can code a still or mobile image, a sound, etc. As described above and referring to FIG. 6, the table TKi is hidden, using steganography, in a media file MS recorded on the mobile terminal TM. The media file MS in which the table TKi is hidden is stored in a memory area of the mobile terminal TM.

The media file MS can be recorded as soon as the mobile terminal TM is designed but has preferably been downloaded during an initialisation phase shown in FIG. 5. In this case and in the same manner described above, the mobile terminal TM sends an initial request Reqᵢₙᵢₜ to the server S to download the resources of a computer application associated with one or more functions that the client wishes to obtain. This initial request comprises a password PWD possibly associated with the client's user name. When the server S receives this initial request Reqᵢₙᵢₜ, it authenticates the password and generates a table TKi associating the indexes 0, 1, . . . , i to the secret keys K0, K1, . . . Ki. The table TKi generated is specific to each client. Then, the server S applies a steganography algorithm AS_{PWD} bootstrapped by the password PWD, to hide the table TKi in a media file MS, which is preferably part of the resources of the computer application. Then the server S transfers the resources of the computer application, including the media file MS containing the table TKi to the mobile terminal TM. Only the table TKi can be stored on the server S side, but it is preferred to record the media file MS in the memory thereof.

Referring to FIG. 7, after having received the authentication request Req from the mobile terminal TM, the server S sends a challenge Def containing an index i from the table TKi to the latter. As mentioned above, the challenge Def can also comprise a random number n and a time marker t. When the mobile terminal TM receives the challenge Def, it extracts the table TKi from the media file MS by executing a reverse steganography algorithm AS_{PWD}.

This reverse steganography algorithm AS_{PWD} can be installed in the mobile terminal TM soon after its conception or, preferably, is part of the resources downloaded during the initialisation phase. After analysing the index i received with the challenge Def, the secret key Ki associated with said index is then extracted from the table TKi. A response R to the challenge Def is then generated, with said response consisting in encoding the secret key Ki thus extracted and possibly the random number n and the time marker t using an encoding algorithm Enc known to the server S and the mobile terminal TM. At the same time, the server S generates a standard response R′ consisting in encoding the challenge Def combined with the secret key Ki, and possibly the random number n and the time marker t using the same encoding algorithm Enc.

If the media file MS including the table TKi is recorded in the memory of the server S, the latter pre-extracts said table from the file by executing the reverse steganography algorithm AS_{PWD} matching the password PWD, then extracts the secret key Ki associated with the index i from the table. After having generated its response R, the mobile terminal TM transmits it to the server S. The latter compares the response R received with the standard response R′. If the response R matches the standard response R′, the mobile terminal TM is authenticated and the server S can activate the functions desired by the client. If not so, an error message can be sent by the server S to the mobile terminal TM.

The encoding algorithm Enc, which makes it possible to generate the response R at the mobile terminal TM and the standard response R′ at the server S, is a coding or encryption algorithm, preferably a coding algorithm (used for the transfer) combined with an encryption (encyphering) and including a hashing function. The hashing function makes it possible to increase the entropy of the responses R, R′ to the challenge Def. In practice, the algorithm used is the combination of an encryption/hashing algorithm (for example of MD5, MD6, SHA-1, SHA-2 type) or changes in the latter, with an encoding algorithm (for example in Base64). The Response R or R′ can, for example, be calculated using the following formula: R or R′=Base64[SHA-256(n+t+Ki)]

What is claimed is:

1. A method for authenticating a client mobile terminal on a remote server of the terminal, the method comprising using the server to a challenge to the mobile terminal in advance, the mobile terminal having to respond to the challenge, to authenticate at the same time, by transmitting a response including encoding said challenge combined with a secret key known to the terminal and the same time to the server, and hiding the secret key in a media file recorded on the mobile terminal using steganography.

2. A method according to claim 1, further comprising:
sending an authentication request from the mobile terminal to the server;
sending a challenge from the server to the mobile terminal;
extracting the secret key from the media file by executing a reverse steganography algorithm at the mobile terminal;
generating:
a response to the challenge at the mobile terminal, as the response consists in encoding the challenge combined with the secret key using an encoding algorithm known to the server and the terminal;
a standard response to the challenge at the server, with the standard response including encoding the challenge combined with the secret key using the same encoding algorithm;
sending the response from the mobile terminal to the server;
comparing at the server, the response received with the standard response; and
authenticating the mobile terminal if the response matches the standard response.

3. A method according to claim 1, further comprising an initialisation phase comprising:
sending an initial request to download the resources of a computer application associated with a function from the mobile terminal to the server, as the request includes a client password known to the terminal and to the server;
authenticating the received client password, at the server and generating a secret key;
hiding the secret key in a media file at the server, by applying a steganography algorithm bootstrapped by the client password; and
transferring the resources of the computer application, including the media file containing the secret key, from the server to the mobile terminal.

4. A method according to claim 2, wherein the challenge comprises a random number and a time marker, in addition to the secret key, with the generation of the standard response at the mobile terminal and the standard response at the server consisting in encoding: the secret key, the random number and the time marker using an algorithm known to the server and terminal.

5. A method according to claim 1, in which:
multiple secret keys are associated with indexes in a table, with the latter being hidden in a media file recorded in the mobile terminal using steganography;
the challenge sent by the server includes an index from the table; and
the response sent by the mobile terminal includes the secret key associated with the index.

6. A method according to claim 5, further comprising:
sending an authentication request from the mobile terminal to the server;
sending a challenge comprising an index from the table from the server to the mobile terminal;
extracting, at the mobile terminal, the table from the media file by executing a reverse steganography algorithm, then extracting the secret key associated with the index from the table;
generating:
a response to the challenge at the mobile terminal, as the response includes encoding the challenge combined with the secret key associated with the index using an encoding algorithm known to the server and the terminal;
a standard response to the challenge at the server, with the standard response including encoding the challenge combined with the secret key associated with the index using the same encoding algorithm;
sending the response, from the mobile terminal to the server;
comparing at the server, the response received with the standard response; and
authenticating the mobile terminal if the response matches the standard response.

7. A method according to claim 5, comprising an initialisation phase comprising:
sending an initial request to download the resources of a computer application associated with a function from the mobile terminal to the server, as the request includes a client password known to the terminal and to the server;
authenticating the client password received, at the server, and generating a table associating the indexes with the secret keys;
hiding the table in a media file at the server, by executing a steganography algorithm bootstrapped by the client password; and
transferring the resources of the computer application, including the media file containing the table, from the server to the mobile terminal.

8. A method according to claim 6, wherein the challenge comprises a random number and a time marker, in addition to the index, with the generation of the response at the mobile terminal and the standard response at the server includes encoding: the secret key associated with the index, the random number and the time marker using an algorithm known to the server and terminal.

9. A method according to claim 3, wherein the media file is an image file, which is part of the resources of a computer application downloaded in the mobile terminal.

10. A method according to claim 3, wherein the media file is an audio file, which is part of the resources of a computer application downloaded in the mobile terminal.

11. A method according to claim 3, wherein the media file is a video file, which is part of the resources of a computer application downloaded in the mobile terminal.

12. A method according to claim 1, wherein the media file containing the secret key or the table is also recorded in the memory of the server.

13. A method according to claim 12 wherein, before generating the standard response, the server extracts the secret key from the media file recorded in the memory thereof by executing a reverse steganography algorithm.

14. A method according to claim 12, wherein, before generating the standard response, the server extracts the table from the media file recorded in the memory thereof by executing a reverse steganography algorithm, then extracts the secret key associated with the index from the table.

15. A method according to claim 1, wherein the encoding algorithm, which makes it possible to generate the response at the mobile terminal and the standard response at the server, is a coding and encryption algorithm, which integrates a hashing function.

16. A device for authenticating comprising a client mobile terminal with a remote server of the terminal, the server sending a challenge to the mobile terminal in advance, the mobile terminal being configured to respond to the challenge by transmitting a response including encoding the challenge combined with a secret key known to the terminal and the same time to the server, the secret key being hidden in a media file recorded in the mobile terminal using steganography.

17. A device according to claim 16, wherein:
the mobile terminal includes a memory area, where a media file is recorded, in which a table associating the indexes to the secret keys is hidden using steganography;
the server comprises a processor configured for sending a challenge including an index from the table; and
the mobile terminal comprises a processor configured to issue a response to the challenge, with the response including the challenge combined with the secret key associated with the index transmitted with the challenge.

18. A device according to claim 17, wherein:
the mobile terminal comprises a processor configured to:
send an authentication request to the server;
extract the table from the media file by applying a reverse steganography algorithm, and extract the secret key associated with an index transmitted by the server from the table;
execute an algorithm, which makes it possible to encode a challenge signal combined with the secret key associated with the index for generating a response to the challenge;
send a response to the server;
the server comprises a processor configured to:
generate and send a challenge signal comprising an index from the table to the mobile terminal;
execute an algorithm, which makes it possible to encode a challenge signal combined with the secret key associated with the index for generating a standard response to the challenge;
compare the response transmitted by the mobile terminal with the standard response; and
authenticating the mobile terminal if the response matches the standard response.

19. A device according to claim 17, wherein the server comprises a processor configured to:
generate the table associating the indexes with the secret keys;
execute a steganography algorithm, which makes it possible to hide the table in a media file; and
transfer this media file to the memory area of the mobile terminal.

20. A mobile terminal intended to be used for implementing the method according to claim 1, with the terminal comprising a memory area, where a media file is recorded, in which a secret key is hidden using steganography.

21. A mobile terminal intended to be used for implementing the method according to claim 5, with the terminal comprising a memory area, where a media file is recorded, in which a table associating the indexes with the secret keys is hidden using steganography.
